(19) United States
(12) Patent Application Publication
(10) Pub. No.: US 2023/0109638 A1
(43) Pub. Date: Apr. 6, 2023

(54) AUTOMATIC DISHWASHING COMPOSITION COMPRISING AT LEAST ONE IMIDAZOLE-BASED COMPOUND

(71) Applicant: BASF SE, Ludwigshafen am Rhein (DE)

(72) Inventors: Stephan HUEFFER, Ludwigshafen (DE); Torben ADERMANN, Ludwigshafen (DE); Kati SCHMIDT, Ludwigshafen (DE); Roland ETTL, Ludwigshafen (DE); Tobias URBAN, Ludwigshafen (DE)

(21) Appl. No.: 17/802,653

(22) PCT Filed: Feb. 24, 2021
(86) PCT No.: PCT/EP2021/054534

§ 371 Date: Aug. 26, 2022

(30) Foreign Application Priority Data
Feb. 28, 2020 (EP) 20160045.9

(51) Int. Cl. C11D 3/00; C11D 11/00; C11D 1/825; C11D 3/395; C11D 3/08; C11D 3/10; C11D 3/04; C11D 3/37; C11D 3/28; C11D 3/33; C11D 3/20

(52) U.S. Cl. CPC C11D 3/0073; C11D 11/0017; C11D 1/825; C11D 3/3953; C11D 3/08; C11D 3/10; C11D 3/046; C11D 3/3757; C11D 3/378; C11D 3/28; C11D 3/3723; C11D 3/33; C11D 3/2086; C11D 1/662

(57) ABSTRACT

Described herein is an automatic dishwashing (ADW) composition including as component (A) at least one imidazole-based compound selected from the group consisting of unsubstituted or at least monosubstituted imidazole and benzimidazole. The automatic dishwashing composition may include further components, such as polyakylene imines (component (B)), at least one silicate (component (C)) and/or at least one chelating agent (component (D)). Also described herein is a process for cleaning dishware using said ADW composition as well as a method of using said ADW composition, for example, to reduce any corrosion on the items to be dishwashed (dishware). Also described herein is a method of using at least one imidazole-based compound according to component (A) as a corrosion inhibitor in automatic dishwashing processes.

The present invention relates to an automatic dishwashing (ADW) composition comprising as component (A) at least one imidazole-based compound selected from the group consisting of unsubstituted or at least monosubstituted imidazole and benzimidazole as defined below in further detail. The inventive automatic dishwashing composition may contain further components, such as polyakylene imines (component (B)), at least one silicate (component (C)) and/or at least one chelating agent (component (D)). The present invention further relates to a process for cleaning dishware employing said ADW composition according to the present invention as well as to the use of said ADW composition, for example, to reduce any corrosion, such as silver corrosion on the items to be dishwashed (dishware). Beyond that, the present invention relates to the use of at least one imidazole-based compound according to component (A) as corrosion inhibitor in such automatic dishwashing processes.

Modern cleaning compositions need to meet many requirements. They need to work under various conditions, for example various temperatures. They need to yield excellent results, in the case of hard surface cleaners and in particular automatic dishwashing formulations they need to provide excellent results with respect to spotting and filming. In case glass is to be cleaned, glass corrosion needs to be inhibited or at least strongly reduced. Cleaning compositions need to be environmentally friendly, and they have to work even under conditions where only so-called “hard water” is available, for example water with a comparatively high content of Mg²⁺ and Ca²⁺ salts.

Cleaning compositions as such, especially for being used within automatic dishwashing processes, are known to a person skilled in the art. For example, WO 2013/160132 relates to the use of solid formulations with a residual moisture content ranging from 0.1 to 1 weight % containing (among others) at least one compound selected from aminocarboxylates and polyaminocarboxylates, at least one cationic (co)polymer with a specific cationic charge density and at least one silicate, such as sodium silicates.

WO 2019/197315 relates to a process for cleaning dishware soiled with fatty residue, characterized in that said process is carried out at a temperature in the range of from 45 to 65° C. and using at least one detergent composition, comprising
(A) at least one graft copolymer comprising—as a graft base—a polyether that may be capped with C₁-C₂₀-alkyl or C₆-C₂₀-2-hydroxyalkyl, and comprising side chains bearing C₄-C₂₀-fatty acid groups or C₆-C₂₀-alkoholate groups,
(B) at least one non-ionic surfactant according to general formula (I)

R¹—CH(OH)—CH₂—O-(AO)ₓ—R² (1).

EP 19209442.3 relates to cleaning compositions containing
(A) at least one chelating agent selected from alkali metal salts of methyl glycine diacetic acid (MGDA) and of citric acid,
(B) glycine or alanine or an alkali metal or ammonium salt of at least one of the foregoing,
in a weight ratio of (A):(B) of from 10:1 to 1:10.

None of the above-mentioned cleaning compositions disclose any imidazole-based compounds according to component (A) of the present invention as mandatory or optional components within the respective compositions. The same holds true for the use of such components as corrosion inhibitors, in particular for inhibiting the corrosion of silver and/or aluminium dishware during an automatic dishwashing process.

US-A 2016/0348252 discloses a method of using nitrogen-containing compounds as corrosion inhibitors. The respective method is used to inhibit corrosion of a metal surface in contact with an aqueous system using 2-substituted imidazoles or benzimidazoles. The method comprises the use of corrosion inhibitors that are generally resistant to halogen attack and provide good corrosion resistance in the presence of oxidizing halogen-based biocides. However, US-A 2016/0348252 does not disclose any automatic dishwashing compositions at all. Furthermore, it does not disclose any corrosion inhibiting effects in connection with silver and/or aluminium-containing dishware.

Irrespective of that, the problem of corrosion, in particular of silver protection, within automatic dishwashing (ADW) is well-known. For example, GB-B 1,131,738 discloses alkaline dish detergent compositions based on benzotriazols (BTA) as corrosion inhibitor for silver. BTA and derivatives thereof are widely used within cleaning compositions including automatic dish washing compositions as described above in context with EP 19209442.3 or WO 2019/197315. However, triazol-based components, such as BTA, are now known to have a potential risk in respect of a endocrinic disrupter, which might lead to a ban of BTA and derivatives thereof.

The object of the present invention, therefore, was to provide a novel ADW composition as an alternative to ADW compositions containing benzotriazol (BTA) or derivatives thereof as corrosion inhibitors, in particular as corrosion inhibitors for silver and/or aluminium-containing dishware.

The object is achieved by an automatic dishwashing composition (ADW composition) comprising component (A)
(A) at least one imidazole-based compound selected from the group consisting of unsubstituted or at least monosubstituted imidazole and benzimidazole, or a salt of such imidazole-based compounds,
wherein the substituents are selected from C₁-C₃₀-alkyl, C₆-C₁₄-aryl, C₇-C₃₀-aralkyl, —NO₂, —NH₂, C₁-C₆-alkoxy, —COOH, halogen or —OH,
and the alkyl or aryl fragments of these substituents may in turn be at least monosubstituted by —COOH, —NH₂, C₁-C₆-alkyl, halogen, C₁-C₆-alkoxy, —NO₂ or —OH.

An advantage of the present invention can be seen in the fact that ADW compositions are provided which have a high potential as corrosion inhibitors, in particular as corrosion inhibitors for silver and/or aluminium-containing dishware. In respect of aluminium-containing dishware, it has to be noted that such aluminium dishware (pots etc.) is predominantly made of aluminium alloys containing copper. If released copper ions are not neutralized/eliminated, the Cu ions catalyse the corrosion of other metals and the dish machine itself can be deteriorated, without using any BTA or derivatives thereof. By consequence, the ADW compositions of the present invention have the general advantage of the provision of a new type of ADW compositions having good washing properties in connection with good corrosion inhibition properties without employing any BTA or derivatives thereof.

In the context of the present invention, definitions such as C₁-C₃₀-alkyl, such as defined, for example, for component (A) above, signifies that this substituent (radical) is an alkyl radical having a carbon atom number of 1 to 30, wherein substituents optionally present are not taken into consideration in the carbon atom number. The alkyl radical may be either linear or branched as well as optionally cyclic. Alkyl radicals having both a cyclic and a linear component also fall under this definition. The same applies to other alkyl radicals such as a C₁-C₆-alkyl radical or a C₁-C₁₂-alkyl radical for example. Examples of alkyl radicals are methyl, ethyl, n-propyl, sec-propyl, n-butyl, sec-butyl, isobutyl, 2-ethylhexyl, tertiary-butyl (tert-Bu/t-Bu), pentyl, hexyl, heptyl, cyclohexyl, octyl, nonyl or decyl.

In the context of the present invention, the term “aryl” or the term “C₆-C₁₄-aryl”, as defined, for example, for component (A) above, signifies that the substituent (radical) is an aromatic system. The corresponding aromatic system has a carbon atom number of 6 to 14, wherein substituents optionally present are not taken into consideration in the carbon atom number. The aromatic system may be a monocyclic, bicyclic or optionally polycyclic aromatic system. In the case of bicyclic or polycyclic aromatic systems, individual rings may optionally be fully or partially saturated. Preferably, all rings of the corresponding aromatic systems are fully unsaturated. Preferred examples of aryl are phenyl, naphthyl or anthracyl, especially phenyl.

In the context of the present invention, the definition “C₇-C₃₀-aralkyl”, as defined for example for component (A) above, signifies that the substituent (radical) comprises an alkyl radical (such as C₁-C₆-alkyl according to the definitions above), wherein this alkyl radical is in turn substituted by an aryl radical (according to the definitions above). The corresponding aralkyl substituent has a carbon atom number of 7 to 30, wherein substituents optionally present are not taken into consideration in the carbon atom number. The alkyl radical itself present therein may be either linear or branched as well as optionally cyclic.

In the context of the present invention, the term “C₁-C₆-alkoxy”, as defined for example as (additional) substituent of component (A) above, signifies that it is a substituent (radical) in this case which is derived from an alcohol. The corresponding substituent thus comprises an oxygen fragment (—O—), which is in turn linked to an alkyl radical, such as C₁-C₆-alkyl (according to the definitions above). The alkyl radical itself may be either linear or branched as well as optionally cyclic.

In the context of the present invention, the term “halogen”, such as defined for example for component (A) above, signifies that the substituent (radical) is fluorine, chlorine, bromine or iodine, halogen, preferably being fluorine or chlorine, particularly preferably chlorine.

In the context of the present invention, the term “unsubstituted or at least monosubstituted imidazole and benzimidazole”, such as defined for example for component (A) above, signifies that each of the in total two substituents (radicals) detailed corresponding to their definitions already specified above may be present either in unsubstituted form or have at least one further substituent (monosubstituted). If one or more substituents are present (for example disubstituted, trisubstituted or even higher substituted), the appropriate substituents are selected independently of one another from the substituent groups specified in each case.

In the case of a disubstituted C₆-C₁₄-aryl for example, the corresponding aryl unit, such as phenyl for example, may be substituted for example by an hydroxyl and a C₁-C₆-alkyl substituent, such as methyl or ethyl. Alkyl or aryl fragments may themselves in turn comprise at least one additional substituent according to the definitions stated. The substitution may be at any desired position of the corresponding fragment.

The present invention is further specified herein below.

The first subject of the present invention is an automatic dishwashing composition (ADW composition) comprising component (A)
(A) at least one imidazole-based compound selected from the group consisting of unsubstituted or at least monosubstituted imidazole and benzimidazole, or a salt of such imidazole-based compounds,
wherein the substituents are selected from C₁-C₃₀-alkyl, C₆-C₁₄-aryl, C₇-C₃₀-aralkyl, —NO₂, —NH₂, C₁-C₆-alkoxy, —COOH, halogen or —OH,
and the alkyl or aryl fragments of these substituents may in turn be at least monosubstituted by —COOH, —NH₂, C₁-C₆-alkyl, halogen, C₁-C₆-alkoxy, —NO₂ or —OH.

The imidazole-based compounds as such, as defined above in connection with component (A), to be employed within automatic dishwashing compositions are known to a person skilled in the art. The imidazole-based compounds according to component (A) are preferably employed within such automatic dishwashing compositions in order to be used as corrosion inhibitor, in particular in connection with the silver and/or aluminium corrosion on items to be dishwashed (dishware).

In case the imidazole-based compound according to component (A) is present as a salt, the person skilled in the art knows the respective salts therefrom. Salts may be employed as component (A), especially in case of a —COOH and/or a —OH substitution. Suitable counterions are, for example, sodium, potassium, or ammonium.

Preferably, the at least one imidazole-based compound selected from the group consisting of unsubstituted or at least monosubstituted imidazole and benzimidazole or a salt of such imidazole-based compounds, wherein the substituents are selected from C₁-C₁₂-alkyl, —NO₂, —NH₂ or —COOH, and C₁-C₁₂-alkyl may in turn be at least monosubstituted by —COOH or —NH₂,

more preferably, the imidazole-based compound is selected from imidazole, 2-ethyl-imidazole, 2-propyl-imidazole, 8-octyl-imidazole, 1-ethyl-4-methyl-imidazole, 2-ethyl-4-methyl-imidazole, 2-amino-3-(1H-imidazol-4-yl)propanoic acid (histidine), 4-methyl-1-p-tolylimidazole, 2-methyl-benzimidazole, benzimidazole and 5-nitro-benzimidazole, most preferably, the imidazole-based compound is selected from 2-ethyl-imidazole, 8-octyl-imidazole, 1-ethyl-4-methyl-imidazole, 2-ethyl-4-methyl-imidazole and 4-methyl-1-p-tolylimidazole.

The automatic dishwashing composition according to the present invention comprises component (A) in any ratio as known to a person skilled in the art. Preferably, component (A) is present within the automatic dishwashing composition in a ratio of 0.05% by weight to 2% by weight, more preferably 0.1% by weight to 1.0% by weight, most preferably 0.25% by weight to 0.75% by weight, each in relation to the total weight of the respective ADW composition, in particular in relation to a dosage of a 18 g composition for each cleaning cycle.

The ADW composition according to the present invention may comprise further components besides the component (A) as defined above. ADW compositions as such, in particular the components usually contained therein, are known to a person skilled in the art.

The ADW composition according to the present invention may comprise as further component (B)
(B) at least one polyalkyleneimine, preferably at least one polyethyleneimine or polypropyleneimine, most preferably at least one polyethyleneimine.

Polyalkyleneimines as such are known to a person skilled in the art. The component (B) according to the present invention is preferably employed within the ADW composition as a further corrosion inhibitor, especially in connection with the inhibition of glass corrosion on the items to be dishwashed (dishware).

Polyalkylenimine may be substituted, for example with CH₂COOH groups or with polyalkyleneoxide chains, or non-substituted. In one embodiment of the present invention, 60 to 80 mole-% of the primary and secondary amine functions of polyalkyleneimines are substituted with CH₂COOH groups or with ethylene oxide or propylene oxide. Particularly preferred are non-substituted polyethylenimine with an average molecular weight M_{w} in a range of from 500 to 20,000 g/mol, determined advantageously by gel permeation chromatography (GPC) in 1.5% by weight aqueous formic acid as eluent and cross-linked poly-hydroxyethylmethacrylate as stationary phase. In other embodiments, polyethoxylated polyethyleneimines are preferred, with an average molecular weight M_{w} in a range of from 2,500 to 50,000 g/mol, determined advantageously by gel permeation chromatography (GPC) in 1.5% by weight aqueous formic acid as eluent and cross-linked poly-hydroxyethylmethacrylate as stationary phase. In other embodiments, polyethoxylated polypropylenimines are preferred, with an average molecular weight M_{w} in a range of from 2,500 to 50,000 g/mol, determined advantageously by gel permeation chromatography (GPC) in 1.5% by weight aqueous formic acid as eluent and cross-linked poly-hydroxyethylmethacrylate as stationary phase.

Polyethyleneimines and polypropylenimines, non-substituted or substituted as above, may applied in small amounts, for example 0.01 to 2% by weight, referring to the total solids content of the respective inventive automatic dishwashing formulation.

The automatic dishwashing composition according to the present invention comprises component (B) in any ratio as known to a person skilled in the art. Preferably, component (B) is present within the automatic dishwashing composition in a ratio of 0.01% by weight to 1% by weight, more preferably 0.05% by weight to 0.50% by weight, most preferably 0.05% by weight to 0.25% by weight, each in relation to the total weight of the respective ADW composition, in particular in relation to a dosage of a 18 g composition for each cleaning cycle.

The ADW composition according to the present invention may contain a further component (C)
(C) at least one silicate, preferably at least one sodium silicate, potassium silicate or alumino silicate, most preferably α-Na₂Si₂O₅, β-Na₂Si₂O₅ or δ-Na₂Si₂O₅.

The silicates according to component (C) as such are known to a person skilled in the art. Suitable examples of such silicates are disclosed, for example, within WO 2013/160132. Examples of suitable silicates include sodium disilicate and sodium metasilicate, zeolites (alumino silicate) as well as sheet silicates.

The automatic dishwashing composition according to the present invention comprises component (C) in any ratio as known to a person skilled in the art. Preferably, component (C) is present within the automatic dishwashing composition in a ratio of 0.1% by weight to 15% by weight, more preferably 0.5% by weight to 10% by weight, most preferably 1% by weight to 5% by weight, each in relation to the total weight of the respective ADW composition, in particular in relation to a dosage of a 18 g composition for each cleaning cycle.

In a preferred embodiment of the present invention, the ADW composition comprises besides component (A) at least one polyalkyleneimine as component (B) as defined above and/or at least one silicate according to component (C) as defined above. More preferably, the ADW composition according to the present invention comprises components (A), (B) and (C) in a weight ratio of 1/0.1-0.3/3-10 (component (A)/component (B)/component (C)).

The ADW composition according to the present invention may comprise a further component (D)
(D) at least one chelating agent selected from salts of methyl glycine diacetic acid (MGDA), of glutamatic acid diacetic acid (GLDA) and of citric acid, preferably the salt is an alkali metal salt or an ammonium salt, more preferably the salt is a sodium salt.

Chelating agents as such, according to component (D), are known to a person skilled in the art. Suitable chelating agents (D) may be defined as follows.

Alkali metal salts may be selected from lithium, potassium, sodium salts and combinations therefrom. Preferred examples of alkali metal cations are sodium and potassium and combinations of sodium and potassium, and even more preferred in compound according to general formula (IIa) and (IIb) as defined below all M are the same and they are all Na. The same goes for alkali metal salts of citric acid mutatis mutandum.

For Example, the Overall Formula of

[CH₃—CH(COO)—N(CH₂—COO)₂]M₃₋ₓHₓ (IIa)

wherein M is selected from ammonium and alkali metal cations, same or different, for example cations of sodium, potassium, and combinations of the foregoing. Even more preferred in compound according to general formula (IIa) all M are the same and they are all Na,

and x in formula (IIa) is in the range of from zero to 1.0, preferably 0.015 to 0.5.

In formula (IIb)

[OOC—CH₂CH₂—CH(COO)—N(CH₂—COO)₂]M₄₋ₓHₓ (IIb)

M is as defined above, and x in formula (IIb) is in the range of from zero to 2.0, preferably 0.015 to 1.0. M has been defined above.

MGDA and its respective alkali metal salts are selected from the racemic mixtures, the D-isomers and the L-isomers, and from mixtures of the D- and L-isomers other than the racemic mixtures. Preferably, MGDA and its respective alkali metal salts are selected from the racemic mixture and from mixtures containing in the range of from 55 to 85 mole-% of the L-isomer, the balance being D-isomer. Particularly preferred are mixtures containing in the range of from 60 to 80 mole-% of the L-isomer, the balance being D-isomer. Other particularly preferred embodiments are racemic mixtures and the L-isomer.

GLDA and its respective alkali metal salts are selected from the racemic mixtures, the D-isomers and the L-isomers, and from mixtures of the D- and L-isomers other than the racemic mixtures. Preferably, GLDA and its respective alkali metal salts are selected from the racemic mixture and from mixtures containing in the range of from 55 to 99 mole-% of the L-isomer, the balance being D-isomer. Particularly preferred are mixtures containing in the range of from 60 to 98.5 mole-% of the L-isomer, the balance being D-isomer. Other particularly preferred embodiments are racemic mixtures.

In any way, the chelating agent according to component (D) may bear a cation other than alkali metal. It is thus possible that minor amounts, such as 0.01 to 5 mol-% of total MGDA, GLDA or citric acid, respectively, bear alkali earth metal cations such as Mg²⁺ or Ca²⁺, or (alkyl)ammonium cation.

In one embodiment of the present invention, chelating agent (D) may contain one or more impurities that may result from the synthesis of the respective chelating agent (D). In the cases of MGDA and GLDA, such impurities may be selected from propionic acid, lactic acid, alanine, nitrilotriacetic acid (NTA) or the like and their respective alkali metal salts. In the case of IDS, such impurities may be selected from maleic acid, monoamides of maleic/fumaric acid, and racemic asparagine. Such impurities are usually present in minor amounts. “Minor amounts” in this context refer to a total of 0.1 to 5% by weight, referring to chelating agent (D), preferably up to 2.5% by weight. In the context of the present invention, such minor amounts are neglected when determining the composition of the inventive composition.

However, it is preferred that the at least one chelating agent (D) contained within an ADW composition according to the present invention is defined as follows
i) the at least one chelating agent is at least one compound selected from the tetra-sodium salt of GLDA, the trisodium salt of MGDA, of GLDA or of citric acid and the disodium salt of MGDA or of citric acid, and/or
ii) the salt of MGDA is provided as mixture of enantiomers or L-isomer, said mixture containing predominantly the respective L-enantiomer with an enantiomeric excess (ee) in the range of from 10 to 75%.

The automatic dishwashing composition according to the present invention comprises component (D) in any ratio as known to a person skilled in the art. Preferably, component (D) is present within the automatic dishwashing composition in a ratio of 1 to 40% by weight of MGDA-trisodium salt and/or 1 to 40% by weight of GLDA-trisodium salt and/or 1 to 40% by weight of trisodium citrate or a mixture thereof which sums up to 5 to 50% by weight of the total weight of the respective ADW composition.

The ADW composition according to the present invention may comprise a further component (E)
(E) at least one surfactant, preferably the at least one surfactant is a non-ionic surfactant.

More preferably, the at least one non-ionic surfactant is a surfactant according to formula (I) as defined below.

Surfactants as such, according to component (E) of the inventive ADW composition, are known to a person skilled in the art. Such a surfactant may be non-ionic, amphoteric (zwitterionic) or anionic.

Examples of suitable non-ionic surfactants are alkoxylated alcohols, di- and multiblock copolymers of ethylene oxide and propylene oxide and reaction products of sorbitan with ethylene oxide or propylene oxide, alkyl polyglycosides (APG), hydroxyalkyl mixed ethers and amine oxides.

Preferred examples of alkoxylated alcohols and alkoxylated fatty alcohols are, for example, compounds of the general formula (III)

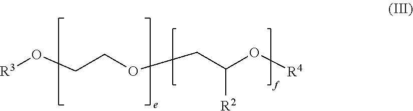

in which the variables are defined as follows:
R² is identical or different and selected from hydrogen and linear C₁-C₁₀-alkyl, preferably in each case identical and ethyl and particularly preferably hydrogen or methyl,
R³ is selected from C₈-C₂₂-alkyl, branched or linear, for example n-C₈H₁₇, n-C₁₀H₂₁, n-C₁₂H₂₅, n-C₁₄H₂₉, n-C₁₆H₃₃ or n-C₁₈H₃₇,
R⁴ is selected from C₁-C₁₀-alkyl, methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-heptyl, n-octyl, 2-ethylhexyl, n-nonyl, n-decyl or isodecyl, The variables e and f are in the range from zero to 300, where the sum of e and f is at least one, preferably in the range of from 3 to 50. Preferably, e is in the range from 1 to 100 and f is in the range from 0 to 30.

In one embodiment, compounds of the general formula (III) may be block copolymers or random copolymers, preference being given to block copolymers.

Other preferred examples of alkoxylated alcohols are, for example, compounds of the general formula (IV)

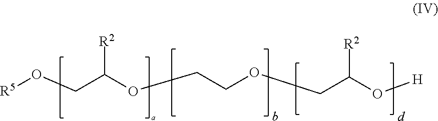

in which the variables are defined as follows:
R² is identical or different and selected from hydrogen and linear C₁-C₄-alkyl, preferably identical in each case and ethyl and particularly preferably hydrogen or methyl,
R⁵ is selected from C₆-C₂₀-alkyl, branched or linear, in particular n-C₈H₁₇, n-C₁₀H₂₁, n-C₁₂H₂₅, n-C₁₃H₂₇, n-C₁₅H₃₁, n-C₁₄H₂₉, n-C₁₆H₃₃, n-C₁₈H₃₇,
a is a number in the range from zero to 10, preferably from 1 to 6,
b is a number in the range from 1 to 80, preferably from 4 to 20,
d is a number in the range from zero to 50, preferably 4 to 25.

The sum a+b+d is preferably in the range of from 5 to 100, even more preferably in the range of from 9 to 50.

Preferred examples for hydroxyalkyl mixed ethers are compounds of the general formula (V)

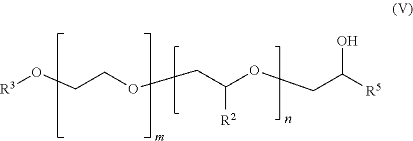

in which the variables are defined as follows:
R² is identical or different and selected from hydrogen and linear C₁-C₁₀-alkyl, preferably in each case identical and ethyl and particularly preferably hydrogen or methyl,
R³ is selected from C₈-C₂₂-alkyl, branched or linear, for example iso-C₁₁H₂₃, iso-C₁₃H₂₇, n-C₈H₁₇, n-C₁₀H₂₁, n-C₁₂H₂₅, n-C₁₄H₂₉, n-C₁₆H₃₃ or n-C₁₈H₃₇,
R⁵ is selected from C₆-C₂₀-alkyl, for example n-hexyl, isohexyl, sec-hexyl, n-heptyl, n-octyl, 2-ethylhexyl, n-nonyl, n-decyl, isodecyl, n-dodecyl, n-tetradecyl, n-hexadecyl, and n-octadecyl.

The variables m and n are in the range from zero to 300, where the sum of n and m is at least one, preferably in the range of from 5 to 50. Preferably, m is in the range from 1 to 100 and n is in the range from 0 to 30.

Compounds of the general formula (IV) and (V) may be block copolymers or random copolymers, preference being given to block copolymers.

Further suitable non-ionic surfactants are selected from di- and multiblock copolymers, composed of ethylene oxide and propylene oxide. Further suitable nonionic surfactants are selected from ethoxylated or propoxylated sorbitan esters. Amine oxides or alkyl polyglycosides, especially linear C₄-C₁₆-alkyl polyglucosides and branched C₈-C₁₄-alkyl polyglycosides such as compounds of general average formula (VI) are likewise suitable.

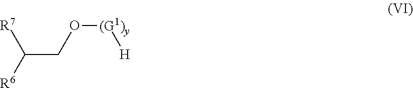

wherein:
R⁶ is C₁-C₄-alkyl, in particular ethyl, n-propyl or isopropyl,
R⁷ is —(CH₂)₂—R⁶,
G¹ is selected from monosaccharides with 4 to 6 carbon atoms, especially from glucose and xylose,
y in the range of from 1.1 to 4, y being an average number,

Further examples of non-ionic surfactants are compounds of general formula (VII) and (VIII)

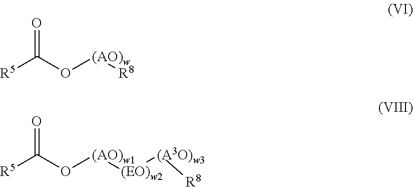

AO is selected from ethylene oxide, propylene oxide and butylene oxide,
EO is ethylene oxide, CH₂CH₂—O,
R⁸ selected from C₈-C₁₈-alkyl, branched or linear, and R⁵ is defined as above.
A³O is selected from propylene oxide and butylene oxide,
w is a number in the range of from 15 to 70, preferably 30 to 50,
w1 and w3 are numbers in the range of from 1 to 5, and
w2 is a number in the range of from 13 to 35.

Preferred non-ionic surfactants to be employed as component (E) within the context of the present invention are disclosed within WO 2019/197315. Such non-ionic surfactants are also called mixed hydroxymethylethers or “HME” or “HME ethers”. The non-ionic surfactant according to general formula (I) is defined as follows

R¹—CH(OH)—CH₂—O-(AO)ₓ—R² (I)

wherein:
R¹ selected from C₄-C₃₀-alkyl, straight-chain or branched, and from C₄-C₃₀-alkylene, straight-chain or branched, with at least one C—C double bond,
R² selected from C₁-C₃₀-alkyl, straight-chain or branched, and from C₂-C₃₀-alkylene, straight-chain or branched, with at least one C—C double bond,
x being selected from one to 100,
AO identical or different alkylene oxides, selected from CH₂—CH₂—O, (CH₂)₃—O, (CH₂)₄—O, CH₂CH(CH₃)—O, CH(CH₃)—CH₂—O— and CH₂CH(n-C₃H₇)—O.

Within the above-mentioned definition of the HME ethers according to general formula (I), it is preferred that the respective variables/substituents are defined as follows
R¹ is selected from C₄-C₃₀-alkyl, straight-chain or branched, and from C₄-C₃₀-alkylene, straight-chain or branched, with at least one C—C double bond, preferred is C₄-C₃₀-alkyl, straight-chain or branched, more preferred is straight-chain C₄-C₃₀-alkyl and even more preferred is n-C₁₀-C₁₂-alkyl,
R² is selected from C₁-C₃₀-alkyl, straight-chain or branched, and from C₂-C₃₀-alkylene, straight-chain or branched, with at least one C—C double bond, preferred is C₆-C₂₀-alkyl, more preferred is C₈-C₁₁-alkyl,
x is selected from one to 100, preferably from 5 to 60, more preferably 10 to 50, and even more preferably 20 to 40,
AO is selected from identical or different alkylene oxides, selected from CH₂—CH₂—O, (CH₂)₃—O, (CH₂)₄—O, CH₂CH(CH₃)—O, CH(CH₃)—CH₂—O— and CH₂CH(n-C₃H₇)—O. Preferred example of AO is CH₂—CH₂—O (EO).

In one embodiment of the present invention, (AO), is selected from (CH₂CH₂O)ₓ₁, x1 being selected from one to 50.

In one embodiment of the present invention, (AO)ₓ is selected from —(CH₂CH₂O)ₓ₂—(CH₂CH(CH₃)—O)ₓ₃ and —(CH₂CH₂O)ₓ₂—(CH(CH₃)CH₂—O)ₓ₃, x2 and x3 being identical or different and selected from 1 to 30.

In one embodiment of the present invention, (AO)ₓ is selected from —(CH₂CH₂O)ₓ₄, x4=being in the range of from 10 to 50, AO being EO, and R¹ and R² each being independently selected from C₈-C₁₄-alkyl.

In the context of the present invention, x or x1 or x2 and x3 or x4 are to be understood as average values, the number average being preferred. Therefore, each x or x1 or x2 or x3 or x4—if applicable—can refer to a fraction although a specific molecule can only carry a whole number of alkylene oxide units.

An overview of suitable further nonionic surfactants can be found in EP-A 0 851 023 and in DE-A 198 19 187.

Mixtures of two or more different non-ionic surfactants selected from the foregoing may also be present.

Other surfactants that may be present are selected from amphoteric (zwitterionic) surfactants and anionic surfactants and mixtures thereof.

Examples of amphoteric surfactants are those that bear a positive and a negative charge in the same molecule under use conditions. Preferred examples of amphoteric surfactants are so-called betaine-surfactants. Many examples of betaine-surfactants bear one quaternized nitrogen atom and one carboxylic acid group per molecule. A particularly preferred example of amphoteric surfactants is cocamidopropyl betaine (lauramidopropyl betaine).

Examples of amine oxide surfactants are compounds of the general formula (IX)

R⁹R¹⁰R¹¹N→O (IX)

wherein R⁹, R¹⁰, and R¹¹ are selected independently from each other from aliphatic, cycloaliphatic or C₂-C₄-alkylene C₁₀-C₂₀-alkylamido moieties. Preferably, R⁹ is selected from C₈-C₂₀-alkyl or C₂-C₄-alkylene C₁₀-C₂₀-alkylamido and R¹⁰ and R¹¹ are both methyl.

A particularly preferred example is lauryl dimethyl aminoxide, sometimes also called lauramine oxide. A further particularly preferred example is cocamidylpropyl dimethylaminoxide, sometimes also called cocamidopropylamine oxide.

Examples of suitable anionic surfactants are alkali metal and ammonium salts of C₈-C₁₈-alkyl sulfates, of C₈-C₁₈-fatty alcohol polyether sulfates, of sulfuric acid half-esters of ethoxylated C₄-C₁₂-alkylphenols (ethoxylation: 1 to 50 mol of ethylene oxide/mol), C₁₂-C₁₈ sulfo fatty acid alkyl esters, for example of C₁₂-C₁₈ sulfo fatty acid methyl esters, furthermore of C₁₂-C₁₈-alkylsulfonic acids and of C₁₀-C₁₈-alkylarylsulfonic acids. Preference is given to the alkali metal salts of the aforementioned compounds, particularly preferably the sodium salts.

Further examples for suitable anionic surfactants are soaps, for example the sodium or potassium salts of stearic acid, oleic acid, palmitic acid, ether carboxylates, and alkylether phosphates.

In one embodiment of the present invention, inventive compositions may contain 0.1 to 60% by weight of at least one surfactant, selected from anionic surfactants, amphoteric surfactants and amine oxide surfactants, preferably 1% by weight to 15% by weight, most preferably 2% by weight to 8% by weight, each in relation to the total weight of the respective ADW composition.

In a preferred embodiment of the present invention, the automatic dishwashing composition comprises i) component (A) as defined above and ii) component (E), wherein component (E) is at least one non-ionic surfactant according to general formula (I)

R¹—CH(OH)—CH₂—O-(AO)ₓ—R² (I)
wherein:
R¹ selected from C₄-C₃₀-alkyl, straight-chain or branched, and from C₄-C₃₀-alkylene, straight-chain or branched, with at least one C—C double bond,
R² selected from C₁-C₃₀-alkyl, straight-chain or branched, and from C₂-C₃₀-alkylene, straight-chain or branched, with at least one C—C double bond,
x being selected from one to 100,
AO identical or different alkylene oxides, selected from CH₂—CH₂—O, (CH₂)₃—O, (CH₂)₄—O, CH₂CH(CH₃)—O, CH(CH₃)—CH₂—O— and CH₂CH(n-C₃H₇)—O.

The ADW composition according to the present invention may comprise a further component (F), which is at least one bleaching agent. Bleaching agents as such are known to a person skilled in the art. Bleaching agents are also referred to as bleach. The bleaching agent may comprise besides the bleach as such at least one bleach catalyst and/or at least one bleach activator.

Bleaching agents may be selected from chlorine bleach and peroxide bleach, and peroxide bleach may be selected from inorganic peroxide bleach and organic peroxide bleach. Preferred are inorganic peroxide bleaches, selected from alkali metal percarbonate, alkali metal perborate and alkali metal persulfate. Inventive compositions that are liquid preferably do not contain both bleaching agent and enzyme.

Examples of organic peroxide bleaches are organic percarboxylic acids, especially organic percarboxylic acids.

In inventive compositions, alkali metal percarbonates, especially sodium percarbonates, are preferably used in coated form. Such coatings may be of organic or inorganic nature. Examples are glycerol, sodium sulfate, silicate, sodium carbonate, and combinations of at least two of the foregoing, for example combinations of sodium carbonate and sodium sulfate.

Suitable chlorine-containing bleaches are, for example, 1,3-dichloro-5,5-dimethylhydantoin, N-chlorosulfamide, chloramine T, chloramine B, sodium hypochlorite, calcium hypochlorite, magnesium hypochlorite, potassium hypochlorite, potassium dichloroisocyanurate and sodium dichloroisocyanurate.

Inventive compositions may comprise, for example, in the range from 3 to 10% by weight of chlorine-containing bleach and/or a peroxide bleach.

Inventive compositions may comprise one or more bleach catalysts. Bleach catalysts can be selected from bleach-boosting transition metal salts or transition metal complexes such as, for example, manganese-, iron-, cobalt-, ruthenium- or molybdenum-salen complexes or carbonyl complexes. Manganese, iron, cobalt, ruthenium, molybdenum, titanium, vanadium and copper complexes with nitrogen-containing tripod ligands and also cobalt-, iron-, copper- and ruthenium-amine complexes can also be used as bleach catalysts.

Inventive compositions may comprise one or more bleach activators, for example N-methylmorpholinium-acetonitrile salts (“MMA salts”), trimethylammonium acetonitrile salts, N-acylimides such as, for example, N-nonanoylsuccinimide, 1,5-diacetyl-2,2-dioxohexahydro-1,3,5-triazine (“DADHT”) or nitrile quats (trimethylammonium acetonitrile salts).

Further examples of suitable bleach activators are tetraacetylethylenediamine (TAED) or tetraacetylhexylenediamine.

It is preferred that the component (F) is
(F) at least one bleaching agent comprising i) a chlorine bleach and/or preferably a peroxide bleach, ii) a bleach catalyst, and/or iii) at least one bleach activator,
more preferably, the peroxide bleach comprises at least one inorganic peroxide bleach, most preferably, at least one alkali metal percarbonate, and/or
more preferably, the at least one bleach activator is tetraacetylethylenediamine (TAED) or tetraacetylhexylenediamine.

The automatic dishwashing composition according to the present invention comprises component (F) in any ratio as known to a person skilled in the art. Preferably, component (F) is present within the automatic dishwashing composition in a ratio of 0.1% by weight to 25% by weight, more preferably 0.5% by weight to 15% by weight, most preferably 3% by weight to 15% by weight, each in relation to the total weight of the respective ADW composition, in particular in relation to a dosage of a 18 g composition for each cleaning cycle.

The weight ratio of bleaching agent to beach catalyst is preferably 100/1 to 2/1.

The ADW composition according to the present invention may comprise a further component (G), which is at least one builder. Builders as such are known to a person skilled in the art. The builder may be an inorganic builder and/or an organic builder.

Examples of suitable inorganic builders are sodium sulfate or sodium carbonate, also fatty acid sulfonates, α-hydroxypropionic acid, alkali metal malonates, fatty acid sulfonates, alkyl and alkenyl disuccinates, tartaric acid diacetate, tartaric acid monoacetate, oxidized starch, and polymeric builders, for example polycarboxylates and polyaspartic acid.

Examples of organic builders are especially homopolymers of (meth)acrylic acid or a copolymer of acrylic acid with at least one comonomer selected from methacrylic acid, maleic acid, itaconic acid and AMPS, hereinafter jointly also referred to as (co)polymers in each case as free acids or partially or fully neutralized with alkali metal, especially with sodium.

In one embodiment of the present invention, organic builders are selected from polycarboxylates, for example alkali metal salts of (meth)acrylic acid homopolymers or (meth)acrylic acid copolymers.

Examples of suitable comonomers are monoethylenically unsaturated dicarboxylic acids such as maleic acid, fumaric acid, maleic anhydride, itaconic acid and citraconic acid. A suitable polymer is in particular polyacrylic acid, which preferably has an average molecular weight M_{w} in the range from 2000 to 40 000 g/mol, preferably 2000 to 10 000 g/mol, in particular 3000 to 8000 g/mol. Also of suitability are copolymeric polycarboxylates, in particular those of acrylic acid with methacrylic acid and of acrylic acid or methacrylic acid with maleic acid and/or fumaric acid, and in the same range of molecular weight.

It is also possible to use copolymers of at least one monomer from the group consisting of monoethylenically unsaturated C₃-C₁₀-mono- or C₄-C₁₀-dicarboxylic acids or anhydrides thereof, such as maleic acid, maleic anhydride, acrylic acid, methacrylic acid, fumaric acid, itaconic acid and citraconic acid, with at least one hydrophilic or hydrophobic monomer as listed below.

Suitable hydrophobic monomers are, for example, isobutene, diisobutene, butene, pentene, hexene and styrene, olefins with 10 or more carbon atoms or mixtures thereof, such as, for example, 1-decene, 1-dodecene, 1-tetradecene, 1-hexadecene, 1-octadecene, 1-eicosene, 1-docosene, 1-tetracosene and 1-hexacosene, C₂₂-α-olefin, a mixture of C₂₀-C₂₄-α-olefins and polyisobutene having on average 12 to 100 carbon atoms per molecule.

Suitable hydrophilic monomers are monomers with sulfonate or phosphonate groups, and also nonionic monomers with hydroxyl function or alkylene oxide groups. By way of example, mention may be made of: allyl alcohol, isoprenol, methoxypolyethylene glycol (meth)acrylate, methoxypolypropylene glycol (meth)acrylate, methoxypolybutylene glycol (meth)acrylate, methoxypoly(propylene oxide-co-ethylene oxide)(meth)acrylate, ethoxypolyethylene glycol (meth)acrylate, ethoxypolypropylene glycol (meth)acrylate, ethoxypolybutylene glycol (meth)acrylate and ethoxypoly(propylene oxide-co-ethylene oxide)(meth)acrylate. Polyalkylene glycols here may comprise 3 to 50, in particular 5 to 40 and especially 10 to 30 alkylene oxide units per molecule.

Particularly preferred sulfonic-acid-group-containing monomers here are 1-acrylamido-1-propanesulfonic acid, 2-acrylamido-2-propanesulfonic acid, 2-acrylamido-2-methylpropane-1-sulfonic acid (AMPS), 2-methacrylamido-2-methylpropanesulfonic acid, 3-methacrylamido-2-hydroxypropanesulfonic acid, allylsulfonic acid, methallylsulfonic acid, allyloxybenzenesulfonic acid, methallyloxybenzenesulfonic acid, 2-hydroxy-3-(2-propenyloxy)propanesulfonic acid, 2-methyl-2-propene-1-sulfonic acid, styrenesulfonic acid, vinylsulfonic acid, 3-sulfopropyl acrylate, 2-sulfoethyl methacrylate, 3-sulfopropyl methacrylate, sulfomethacrylamide, sulfomethylmethacrylamide, and salts of said acids, such as sodium, potassium or ammonium salts thereof.

Particularly preferred phosphonate-group-containing monomers are vinylphosphonic acid and its salts.

A further example of organic builders is carboxymethyl inulin.

Moreover, amphoteric polymers can also be used as builders.

Within the context of the present invention, component (G) is preferably at least one inorganic builder and/or at least one organic builder,
i) more preferably, the at least one inorganic builder is selected from sodium sulfate or sodium carbonate, and/or
ii) more preferably, the at least one organic builder is at least one homopolymer of (meth)acrylic acid or a copolymer of acrylic acid with at least one comonomer selected from methacrylic acid, maleic acid, itaconic acid and AMPS.

Inventive compositions may comprise, for example, in the range from in total 5 to 70% by weight, preferably up to 50% by weight, of builder. In the context of the present invention, chelating agent (D) and/or the silicates (C) are not counted as builder.

However, the ADW composition according to the present invention may contain further components besides components (A) to (G) as defined above. The ADW composition may comprise at least one further component (H) to (L) selected from at least one enzyme (component (H)), at least one zinc salt (component (I)), at least one antifoam (component (J)), water or at least one solvent (component (K)) or further additives (component (L)).

In a preferred embodiment of the present invention, the ADW composition comprises components (A) to (G) and optionally at least one further component (H) to (L)
(A) at least one imidazole-based compound, which is preferably selected from imidazole, 2-ethyl-imidazole, 2-propyl-imidazole, 8-octyl-imidazole, 1-ethyl-4-methyl-imidazole, 2-ethyl-4-methyl-imidazole, 2-amino-3-(1H-imidazol-4-yl)propanoic acid (histidine), 4-methyl-1-p-tolylimidazole, 2-methyl-benzimidazole, benzimidazole and 5-nitro-benzimindazole,
(B) at least one polyalkylene imine, preferably at least one polyethyleneimine,
(C) at least one silicate, preferably α-Na₂Si₂O₅, p-Na₂Si₂O₅ or 5-Na₂Si₂O₅,
(D) at least one chelating agent, preferably the at least one chelating agent is at least one compound selected from the tetra-sodium salt of GLDA, the trisodium salt of MGDA, of GLDA or of citric acid and the disodium salt of MGDA or of citric acid,
(E) at least one surfactant, preferably at least one non-ionic surfactant according to general formula (I)

R¹—CH(OH)—CH₂—O-(AO)ₓ—R² (I)
wherein:
R¹ selected from C₄-C₃₀-alkyl, straight-chain or branched, and from C₄-C₃₀-alkylene, straight-chain or branched, with at least one C—C double bond,
R² selected from C₁-C₃₀-alkyl, straight-chain or branched, and from C₂-C₃₀-alkylene, straight-chain or branched, with at least one C—C double bond,
x being selected from one to 100,
AO identical or different alkylene oxides, selected from CH₂—CH₂—O, (CH₂)₃—O, (CH₂)₄—O, CH₂CH(CH₃)—O, CH(CH₃)—CH₂—O— and CH₂CH(n-C₃H₇)—O,
(F) at least one bleaching agent, preferably the bleaching agent comprises at least one alkali metal percarbonate and/or tetraacetylethylenediamine (TAED) or tetraacetylhexylenediamine,
(G) at least one builder comprising sodium sulfate, sodium carbonate and/or at least one homopolymer of (meth)acrylic acid or a copolymer of acrylic acid with at least one comonomer selected from methacrylic acid, maleic acid, itaconic acid and AMPS,
and optionally comprising at least one further one further component (H) to (L) selected from at least one enzyme (component (H)), at least one zinc salt (component (I)), at least one antifoam (component (J)), water or at least one solvent (component (K)) or further additives (component (L)).

Within this embodiment, it is preferred that the individual components (A) to (G) are present with the same amount as defined above in connection with the definition of the individual components (A) to (G). The same applies in respect of the individual components (H) to (L) as defined below.

Inventive compositions may comprise one or more enzymes as component (H). Examples of enzymes are lipases, hydrolases, amylases, proteases, cellulases, esterases, pectinases, lactases and peroxidases.

In one embodiment of the present invention, inventive compositions may comprise, for example, up to 5% by weight of enzyme, preference being given to 0.1 to 3% by weight. Said enzyme may be stabilized, for example with the sodium salt of at least one C₁-C₃-carboxylic acid or C₄-C₁₀-dicarboxylic acid. Preferred are formates, acetates, adipates, and succinates.

In one embodiment of the present invention, inventive compositions may comprise at least one zinc salt as component (I). Zinc salts may be selected from water-soluble and water-insoluble zinc salts. In this connection, within the context of the present invention, water-insoluble is used to refer to those zinc salts which, in distilled water at 25° C., have a solubility of 0.1 g/l or less. Zinc salts which have a higher solubility in water are accordingly referred to within the context of the present invention as water-soluble zinc salts.

In one embodiment of the present invention, zinc salt is selected from zinc benzoate, zinc gluconate, zinc lactate, zinc formate, ZnCl₂, ZnSO₄, zinc acetate, zinc citrate, zinc glycinate, Zn(NO₃)₂, Zn(CH₃SO₃)₂ and zinc gallate, preferably ZnCl₂, ZnSO₄, zinc acetate, zinc citrate, Zn(NO₃)₂, Zn(CH₃SO₃)₂ and zinc gallate.

In another embodiment of the present invention, zinc salt is selected from ZnO, ZnO-aq, Zn(OH)₂ and ZnCO₃. Preference is given to ZnO-aq.

In one embodiment of the present invention, zinc salt is selected from zinc oxides with an average particle diameter (weight-average) in the range from 10 nm to 100 μm.

The cation in zinc salt can be present in complexed form, for example complexed with ammonia ligands or water ligands, and in particular be present in hydrated form. To simplify the notation, within the context of the present invention, ligands are generally omitted if they are water ligands.

Depending on how the pH of mixture according to the invention is adjusted, zinc salt can change. Thus, it is for example possible to use zinc acetate or ZnCl₂ for preparing formulation according to the invention, but this converts at a pH of 8 or 9 in an aqueous environment to ZnO, Zn(OH)₂ or ZnO-aq, which can be present in non-complexed or in complexed form.

Zinc salt may be present in those inventive automatic dishwashing formulations which are solid at room temperature are preferably present in the form of particles which have for example an average diameter (number-average) in the range from 10 nm to 100 μm, preferably 100 nm to 5 μm, determined for example by X-ray scattering.

Zinc salt may be present in those detergent compositions for home care applications that are liquid at room temperature in dissolved or in solid or in colloidal form.

In one embodiment of the present invention, inventive automatic dishwashing formulations comprise in total in the range from 0.05 to 0.4% by weight of zinc salt, based in each case on the solids content of the composition in question.

Here, the fraction of zinc salt is given as zinc or zinc ions. From this, it is possible to calculate the counterion fraction.

Inventive compositions may comprise one or more antifoams as component (J), selected for example from silicone oils and paraffin oils.

In one embodiment of the present invention, inventive compositions comprise in total in the range from 0.05 to 0.5% by weight of antifoam.

The ADW composition according to the present invention may contain as component (K) water or at least one solvent. Component (K) is present in case the ADW composition is used as a liquid composition. Suitable solvents (besides water) as component (K) are, for example, glycerine, glycole or 1,2-propandiole. Component (K) may be present in a range of 10 to 75% by weight in relation to the total weight of the respective ADW composition. Moreover, it is also possible to additionally employ at least one thickener together with component (K).

Formulations according to the invention can comprise—together with component (K)—one or more alkali carriers. Alkali carriers ensure, for example, a pH of at least 8 if an alkaline pH is desired. Of suitability are, for example, the alkali metal carbonates, the alkali metal hydrogen carbonates, and alkali metal metasilicates mentioned above, and, additionally, alkali metal hydroxides. A preferred alkali metal is in each case potassium, particular preference being given to sodium.

Together with enzymes (component (K)) also enzyme stabilizing systems which can be considered as a solvent according to component (K) may be used such as for example calcium ions, boric acid, boronic acids, propylene glycol and short chain carboxylic acids. In the context of the present invention, short chain carboxylic acids are selected from monocarboxylic acids with 1 to 3 carbon atoms per molecule and from dicarboxylic acids with 2 to 6 carbon atoms per molecule. Preferred examples are formic acid, acetic acid, propionic acid, oxalic acid, succinic acid, HOOC(CH₂)₃COOH or adipic acid.

In one embodiment of the present invention, inventive compositions comprise one or more further additives as component (L), such as fragrances, dyestuffs, organic solvents, buffers and/or disintegrants for tabs.

In one embodiment of the present invention, inventive compositions are free from heavy metals apart from zinc compounds. Within the context of the present, this may be understood as meaning that inventive compositions are free from those heavy metal compounds which do not act as bleach catalysts, in particular of compounds of iron and of bismuth. Within the context of the present invention, “free from” in connection with heavy metal compounds is to be understood as meaning that the content of heavy metal compounds that do not act as bleach catalysts is in sum in the range from 0 to 100 ppm, determined by the leach method and based on the solids content. Preferably, detergent compositions according to the invention has, apart from zinc, a heavy metal content below 0.05 ppm, based on the solids content of the formulation in question. The fraction of zinc is thus not included.

Within the context of the present invention, “heavy metals” are defined to be any metal with a specific density of at least 6 g/cm³ with the exception of zinc. In particular, the heavy metals are metals such as bismuth, iron, copper, lead, tin, nickel, cadmium and chromium.

Preferably, inventive automatic dishwashing formulations comprise no measurable fractions of bismuth compounds, i.e. for example less than 1 ppm.

In one preferred embodiment of the present invention, the inventive composition is free from any benzotriazole (BTA) or any derivative therefrom (components which may be defined as triazoles). Free from any benzotriazole (BTA) or any derivative therefrom means that the respective composition is preferably entirely free of such components or they may still be present to a maximum amount of <0.1% by weight in relation to the total weight of the ADW composition.

Inventive compositions are excellently suited for various cleaners, e.g., in hard surface cleaning such as, but not limited to automatic dishwashing, and in laundry. They are excellently suited for environmentally friendly cleaning compositions and provide excellent cleaning properties such as spotting and filming even when hard water is used.

Any suitable carrier medium in any suitable amount in any suitable form may be used. Suitable carrier mediums include both liquids and solids depending on the form of the automatic dishwashing composition. A solid carrier medium may be used in dry powders, granules, tablets, encapsulated products, and combinations thereof. Suitable solid carrier mediums include, but are not limited to carrier mediums that are non-active solids at ambient temperature. For example, any suitable organic polymer, such as polyethylene glycol (PEG), may be used. In certain embodiments, the solid carrier medium may be present in an amount in the range from about 0.01% to about 20%, or from about 0.01% to about 10%, and alternatively, from about 0.01% to about 5% by weight of the composition.

Suitable liquid carrier mediums include, but are not limited to: water (distilled, deionized, or tap water), solvents, and mixtures thereof. The liquid carrier medium may be present in an amount in the range from about 1% to about 90%, or from about 20% to about 80%, and alternatively, from about 30% to about 70% by weight of the composition. In through the rinse applications of the composition, low molecular weight primary or secondary alcohols selected from the group consisting of: ethanol, propanol, isopropanol, glycerol, propylene glycol, ethylene glycol, 1,2-propanediol, sorbitol and mixtures thereof may be utilized. The solvents for a through the rinse application is used suitably at a level of from about 5% to about 40%, preferably from about 10% to about 35% and more preferably form about 15% to about 25% by weight of the composition. The liquid carrier medium, however, may also contain other materials which are liquid, or which dissolve in the liquid carrier medium at room temperature, and which may also serve some other function besides that of a carrier. These materials include, but are not limited to: dispersants, hydrotropes, and mixtures thereof.

The composition can be provided in a “concentrated” system. For example, a concentrated liquid composition may contain a lower amount of a suitable carrier medium, compared to conventional liquid automatic dishwasher compositions. Suitable carrier medium content of the concentrated system may be present in an amount from about 30% to about 99.99% by weight of the concentrated composition. The dispersant content of the concentrated system may be present in an amount from about 0.001% to about 10% by weight of the concentrated automatic dishwashing composition.

Dispersant and Crystal Growth Inhibitors

Another adjunct ingredient that may be utilized is a dispersant and crystal growth inhibitors. The function of the dispersant is to suspend the inorganic salts in the wash liquor and minimize their deposition onto dishware. Some dispersants can also act as crystal growth inhibitors.

Suitable for use as dispersants herein are co-polymers synthesized from acrylic acid, maleic acid and methacrylic acid such as ACUSOL® 480N supplied by Rohm & Haas and polymers containing both carboxylate and sulphonate monomers, such as ALCOSPERSE® polymers (supplied by Alco).

Preferred crystal growth inhibitors for use herein include organodiphosphonic acids. By organo diphosphonic acid it is meant herein an organo diphosphonic acid which does not contain nitrogen as part of its chemical structure. This definition therefore excludes the organo aminophosphonates, which however may be included in compositions of the invention as heavy metal ion sequestrant components.

The organo diphosphonic acid is preferably a C₁-C₄ diphosphonic acid, more preferably a C₂ diphosphonic acid, such as ethylene diphosphonic acid, or most preferably ethane 1-hydroxy-1,1-diphosphonic acid (HEDP) and may be present in partially or fully ionized form, particularly as a salt or complex.

Humectants

Another adjunct ingredient for the present composition may be selected as a humectant. Humectants are a substance which can pick up or emit moisture to the surroundings depending on the surrounding relative humidity. Humectants suitable for use herein include non-aqueous hydrophilic organic solvents inclusive of glycols and polyhydric alcohols, for example sorbitol, glycerol, dipropylene glycol and mixtures thereof.

Product Form

Any suitable product form may be used. Suitable product forms include, but not limited to: solids, granules, powders, liquids, gels, pastes, semi-solids, tablets, water-soluble pouches, and combinations thereof. In a preferred embodiment of the present invention the composition forms part of a multi-phase unit dose product, preferably a dual compartment water-soluble pouch, wherein one of the phases preferably comprises a main wash detergent composition.

Preferred compositions and manufacturing methods for unit dose executions are described in WO 02/42408. Any water-soluble film-forming polymer which is compatible with the compositions of the invention and which allows the delivery of the composition into the rinse cycle can be employed in the unit dose embodiment. The film should remains intact during the wash cycle and only dissolves at the beginning of or during the rinse cycle. This can be achieved by modifying the thickness of the film and/or the solubility of the film material. The solubility of the film material can be delayed by for example cross-linking the film as described in WO 02/102,955 at pages 17 and 18. Other water-soluble films designed for rinse release are described in U.S. Pat. No. 4,765,916.

The automatic dishwashing composition suitable herein can be dispensed from any suitable device, including but not limited to: dispensing baskets or cups, bottles (pump assisted bottles, squeeze bottles, etc.), mechanic pumps, multi-compartment bottles, capsules, multi-compartment capsules, paste dispensers, and single- and multi-compartment water-soluble pouches, and combinations thereof. For example, a multi-phase tablet, a water-soluble or water-dispersible pouch, and combinations thereof, may be used to deliver the corrosion inhibitor to the desired substrate. The automatic dishwashing composition may take the form of an additive that is used in addition to one or more other automatic dishwashing compositions.

Delivery of the corrosion inhibitor may be through solutions including but are not limited to: hot and/or cold water, wash and/or rinse liquor, drying stage, and combinations thereof.

Another subject matter of the present invention is a process for cleaning dishware in an automatic dishwasher, wherein said process is performed under use of at least one ADW composition according to the definition above.

Another subject matter of the present invention is the use of at least one ADW composition as described above in automatic dishwashing and/or as corrosion inhibitor, preferably in order to reduce any corrosion at least partially or more preferably avoid any corrosion completely, during automatic dishwashing processes.

Preferred uses are those, wherein the corrosion is silver and/or Cu induced/catalyzed corrosion as a secondary effect of aluminium corrosion on items to be dishwashed (dishware), metal corrosion within the interior of the automatic dishwasher and/or glass corrosion on the items to be dishwashed, preferably the corrosion is silver and/or aluminium corrosion on items to be dishwashed.

Another subject matter of the present invention is the use of at least one imidazole-based compound (component (A)) as defined above as corrosion inhibitor, preferably in order to reduce any corrosion at least partially or preferably avoid any corrosion completely during automatic dishwashing processes; preferably the corrosion is silver and/or Cu induced/catalyzed corrosion as a secondary effect of aluminium corrosion (stainless steel can suffer from this secondary corrosion) on items to be dishwashed and/or the machine.

By consequence, the ADW compositions of the present invention can be employed within a process for cleaning hard surfaces, e.g., dishware, preferably in an automatic dishwasher, hereinafter also referred to as inventive cleaning process. The inventive cleaning process is characterized in that it is performed under use of an inventive composition.

The term “hard surface cleaners” includes compositions for dishwashing, hand dishwash and especially automatic dishwashing and ware-washing, and compositions for other hard surface cleaning such as, but not limited to compositions for bathroom cleaning, kitchen cleaning, floor cleaning, descaling of pipes, window cleaning, car cleaning including truck cleaning, furthermore, open plant cleaning, cleaning-in-place, metal cleaning, disinfectant cleaning, farm cleaning, high pressure cleaning, but not laundry detergent compositions.

Dishware as used hereunder includes china, polymer, metal, clay, and glassware. A process to clean dishware includes removal of all sorts of soil, like fat, proteins, starch, dyes, and more.

More specifically, the term “dishware” includes articles used in the preparation, serving, consumption, and disposal of food stuffs including pots, pans, trays, pitchers, bowls, plates, saucers, cups, glasses, forks, knives, spoons, spatulas, and other glass, metal, ceramic, plastic composite articles commonly available in the institutional or household kitchen or dining room. In general, such dishware can be referred to as food or beverage contacting articles because they have surfaces which are provided for contacting food and/or beverage. When used in these ware-washing applications, cleaning composition and/or rinse aid should provide effective sheeting action and low foaming properties. In addition to having the desirable properties described above, it may also be useful for cleaning compositions and/or rinse aids to be biodegradable, environmentally friendly, and generally nontoxic. A cleaning composition and/or rinse aid of this type may be described as being “food grade”.

The inventive cleaning process is being carried out at temperatures in the range of from 10 to 90° C. In embodiments wherein the inventive cleaning process is carried out as an automatic dishwashing process, it is preferably carried out at a temperature in the range of from 30 to 65° C., more preferably 40 to 60° C. Said temperature refers to the temperature of the water being used in the inventive process.

The inventive process is being carried out using water. In embodiments wherein the inventive cleaning process is carried out as an automatic dishwashing process, the amount of water is influenced by the type of machine used and by the choice of the program.

The water used may have a German hardness in the range of from zero to 25° dH, referring to the permanent hardness.

In embodiments wherein the inventive cleaning process is carried out as an automatic dishwashing process, the inventive cleaning process is preferably performed with a combination of two compositions of which one is an inventive composition, and the other composition comprises a rinse-aid containing, for example, at least one non-ionic surfactant and at least one inorganic salt selected from alkali metal sulfates and alkali metal (bi)carbonates.

The present invention is further illustrated by working examples.

1. Gravimetric Corrosion Test with Test Plates Steel 1.4301 and Copper Cu-EP (CW004A):

2×5 cm test plates (ROCHOLL GmbH) are prepared by cathodic alkaline degreasing and weighed (approx. 7.7 g or 9.1 g).

Electrolyte: 5% NaCl in H₂O adjusted to pH 10.0 with NaOH; the test plate is immersed 3 cm in a bath and stored at 45° C. for three weeks. To the electrolyte for steel plate corrosion tests 25 ppm Cu is added via dosage of 0.1 m copper sulfate solution. The water level and the pH value are checked and corrected every day. Subsequently, the test plates are subjected to a visual inspection/checking, the plates are rinsed with distilled water and dried in a drying cabinet at 40° C. and then weighed.

2. Electrochemical Corrosion Test (Cyclic Polarization) to Determine the Passivation Effect (Method from Literature)

TABLE 1
Compositions

| | | | | | | 2-ethyl | |
|---|---|---|---|---|---|---|---|
| Test | | | 2-ethyl- | 2-propyl- | 2-octyl- | 4methyl- | |
| substance | without | imidazole | imidazole | imidazole | imidazole | imidazole | histidine |
| steel, | 1.45 | 0.81 | 0.45 | 0.41 | 0.54 | 0.34 | 1.1 |
| gravimetric | | | | | | | |
| removal | | | | | | | |
| [mg/cm2] | | | | | | | |
| Cu, | 0.82 | 0.58 | 0.33 | 0.38 | 0.42 | 0.39 | 0.63 |
| gravimetric | | | | | | | |
| removal | | | | | | | |
| [mg/cm2] | | | | | | | |
| annotation | edge | edge | — | — | minor | — | even |
| steel | rust and | rust | | | edge | | removal |
| | pitting | | | | rust | | |
| | corrosion | | | | | | |
| cyclic | | | | | | | |
| polarization | | | | | | | |

| | 2-methyl- | | 5-nitro | | 4-methy1-1-p- |
|---|---|---|---|---|---|
| Test | benz- | benz- | benz- | 4-methy1-1-p- | tolylimidazole + |
| substance | imidazole | imidazole | imidazole | tolylimidazole | 2-ethylimidazole |
| steel, | 0.51 | 0.56 | 0.75 | 0.45 | 0.41 |
| gravimetric | | | | | |
| removal | | | | | |
| [mg/cm2] | | | | | |
| Cu, | 0.40 | 0.43 | 0.54 | 0.43 | 0.34 |
| gravimetric | | | | | |
| removal | | | | | |
| [mg/cm2] | | | | | |
| annotation | — | — | edge | — | — |
| steel | | | rust | | |
| cyclic | | | | | |
| polarization | | | | | |

General Remarks about the Dish-Wash Process:

All dish-wash experiments were carried out in Miele automatic dish wash machines, type G1222 SCL. The program 45° C. (“R-time 2”, for washing) and 55° for rinsing was selected. No separate rinsing agent was added, no regenerating salt was used. The dish-wash experiments were carried out with water, 21° dH (German hardness), Ca/Mg:HCO3 (3:1):1.35. In each experiment three knives (stainless steel) and two silver knifes with stainless steel blade and two silver-spoons were investigated. In addition three blue melamine resin plates, eleven drinking glasses and fourteen plates from china were placed in the dishwasher. Before each cycle, 5 g of Biskin Gold®, a solid vegetable fat, and 5 g of margarine and 50 g additional ballast soil (RA mix) were added. In each cycle of an experiment according to the invention, 18 g of a detergent composition according to table 3 were added.

The compositions according to table 2 were used for making detergent compositions according to the invention and comparison detergent compositions.

TABLE 2
Compositions

| Feed material | Comp-1 | Comp-2 | Comp-3 | Comp-4 | Comp-5 | Comp-6 | Comp-7 | Comp-8 |
|---|---|---|---|---|---|---|---|---|
| Protease | 2.0 | 2.0 | 2.0 | 2.0 | 2.0 | 2.0 | 2.0 | 2.0 |
| Amylase | 1 | 1 | 1 | 1 | 1 | 1 | 1 | 1 |
| n-C₁₂-alkyl polyglucoside | 1 | 1 | 1 | 1 | 1 | 1 | 1 | 1 |
| HME Surfactant | 4 | 4 | 4 | 4 | 4 | 4 | 4 | 4 |
| | Dehypon | Dehypon | Dehypon | Dehypon | Dehypon | Dehypon | Dehypon | Dehypon |
| | E127* | E127 | E127 | E127 | E127 | E127 | E127 | E127 + KI8 |
| | | | | | | | | (19/1)* |
| (P x) Polymer* | 4 P1 | 4 P1 | 1.5 P2 | 1.5 P2 | 1.5 P2 | 1.5 P2 | 1.5 P2 | 4 P1 |
| Sodium percarbonate | 10.0 | 8.0 | 10.0 | 10.0 | 10.0 | 10.0 | 10.0 | 8.0 |
| TAED | 2.5 | 2.5 | 2.5 | 2.5 | 2.5 | 2.5 | 2.5 | 2.5 |
| Inhibitor | | | | | | | | |
| a) 0.4% (“with”) | KI1 | KI2 | KI3 | KI4 | KI5 | KI6 | KI7 | KI2-0.2% |
| b) 0% (“without”) | — | — | — | — | — | — | — | — |
| Na₂Si₂O₅, commercial | 2 | 2 | 3 | 3 | 3 | 3 | 3 | 2 |
| product (Britesil ®) | | | | | | | | |
| Na₂CO₃ | 25 | 25 | 25 | 22 | 22 | 22 | 22 | 22 |
| (A.1) | 10 | — | 10 | 10 | 10 | | 10 | 30 |
| (A.2) | — | 15 | 15 | — | — | 10 | — | — |
| (A.3) | 30 | 30 | 15 | 20 | 20 | 30 | 30 | 15 |
| HEDP | 2.0 | 1.0 | — | — | — | 1.0 | 1.0 | — |

Na₂SO₄ to 100%

*Commercial product, BASF SE
All data in g
(A.1): MGDA-Na3 5
(A.2): GLDA-Na4
(A.3): trisodium citrate
Polymers: P1: homo-polyacrylic acid, 25 mol-% neutralized with sodium hydroxide, Mw: 4,000 g/mol, determined by GPC and referring to the free acid; polymer P2 copolymer 85% by weight acrylic acid, 15% by weight 2-acrylamido-2-methylpropane-1-sulfonic acid (AMPS), fully neutralized with NaOH, Mw 8,000 g/mol, according to CAS No. 40623-75-4.
HEDP: 1,1-1-hydroxyethyldiphosphonic acid
Corrosion Inhibitors: pure compound or Formulation; KI1: Imidazol; KI2: 2-Ethylimidazol; KI3: 2-Octylimidazol; KI4: 2-Ethylimidazol/Lupasol FG (4/1) KI5: 1-Ethyl,4Methylimidazol
KI6: Histidin = 2-Amino-3-(1H-imidazol-4-yl)propansäure/Lupasol FG (6/1); KI7: 4-methy1-1-p-tolylimidazole + 2-Ethylimidazol (1/2), KI 8: Benzimidalzol/Lupasol FG 2.5/1*
*HME Comp 8: 95 g Dehypon E127 were heated to 50° C. and 5 g Benzimidazol dissolved followed by 2 g Lupasol FG and afterwards solidified via cooling. Lupasol (FG) is a commercially available product of BASF SE falling under the definition of a polyethylene imine according to component (B) as defined above.

General Remarks about the Dish-Wash Process:

For avoidance of transfer of corrosion inhibitors, every of 16 experiment (8 with inhibitors and 6 wo) was performed in identical but different machines.

Evaluation

The silver spoons and knives were evaluated; silver surface++ (without any impair on metallic shine);+(minor shades at >5% of surface); 0 shades >5%<20%; —silver surface with yellowish or brownish deposit and minor corrosion on SS blades (knives); —heavy deposits that cannot be removed and severe corrosion on knife blades.

In addition the interior of the dish washing machine was evaluated and any sign of ss corrosion and transfer of brownish blackish deposit was evaluated with—.

TABLE 3
Evaluation

| | Comp-1 | Comp-2 | Comp-3 | Comp-4 | Comp-5 | Comp-6 | Comp-7 | Comp-8 |
|---|---|---|---|---|---|---|---|---|
| | inhibition | inhibition | inhibition | inhibition | inhibition | inhibition | inhibition | inhibition |
| Experiment | without/with | without/with | without/with | without/with | without/with | without/with | without/with | without/with |
| Silver spoons | −−\+ | −\++ | −−\++ | −−\++ | −−\++ | −\+ | −−\++ | −−\++ |
| Silver knives | −−\0 | −−\++ | −−\+ | −−\++ | −−\++ | −−\0 | −−\++ | −−\++ |
| Machine | −−\+ | −\++ | 0\++ | −−\++ | −−\++ | 0\+ | −−\++ | −−\++ |
| Glass: corrosion | 0\0 | 0\0 | 0\0 | −\++ | 0\0 | 0\+ | 0\0 | 0\+ |
| Shine of glass | +\+ | 0\+ | +\++ | 0\++ | 0\++ | 0\+ | 0\0 | 0\++ |
| Sustainability 2* | 0\0 | 0\++ | 0\++ | 0\++ | 0\++ | 0\+ | 0\+ | 0\++ |

2*: sustainability grades have to be compared with the respective use of 0.3% benzotriazole (BTA) instead of the respective corrosion inhibitors as identified above. BTA-based compositions have due to classification as potential endocrine disruptor compound and toxicity to aquatic organism a grade of −−; 0 in the experiments without any silver protection/corrosion inhibitor is a result of silver and/or machine degradation, as also the degradation and corrosion of silver and the machine results in a waste of resources (−−) that contributes to the total sustainability balance which then sums up to zero. ++ in the experiments with additive means: perfect silver and machine protection and overall very good environmental evaluation.

1. An automatic dishwashing composition (ADW composition) comprising component (A)
(A) at least one imidazole-based compound selected from the group consisting of unsubstituted or at least monosubstituted imidazole and benzimidazole, and a salt of such imidazole-based compounds,
wherein the substituents are selected from the group consisting of C₁-C₃₀-alkyl, C₆-C₁₄-aryl, C₇-C₃₀-aralkyl, —NO₂, —NH₂, C₁-C₆-alkoxy, —COOH, halogen and —OH,
and the alkyl or aryl fragments of these substituents may in turn be at least monosubstituted by —COOH, —NH₂, C₁-C₆-alkyl, halogen, C₁-C₆-alkoxy, —NO₂ or —OH,
and further comprising a component (E), wherein component (E) is at least one non-ionic surfactant according to general formula (I)
R¹—CH(OH)—CH₂—O-(AO)ₓ—R² (I)
wherein:
R¹ is selected from the group consisting of C₄-C₃₀-alkyl, straight-chain or branched, and C₄-C₃₀-alkylene, straight-chain or branched, with at least one C—C double bond,
R² is selected from the group consisting of C₁-C₃₀-alkyl, straight-chain or branched, and C₂-C₃₀-alkylene, straight-chain or branched, with at least one C—C double bond,
x is selected from the group consisting of one to 100,
AO is identical or different alkylene oxides, selected from the group consisting of CH₂—CH₂—O, (CH₂)₃—O, (CH₂)₄—O, CH₂CH(CH₃)—O, CH(CH₃)—CH₂—O— and CH₂CH(n-C₃H₇)—O.

2. The ADW composition according to claim 1 further comprising a component (B)
(B) at least one polyalkyleneimine.

3. The ADW composition according to claim 1 further comprising a component (C)
(C) at least one silicate.

4. The ADW composition according to claim 1, wherein the substituents are selected from the group consisting of C₁-C₁₂-alkyl, —NO₂, —NH₂ and —COOH, and wherein C₁-C₁₂-alkyl may in turn be at least monosubstituted by —COOH or —NH₂.

5. The ADW composition according to claim 1, further comprising a component (D)
(D) at least one chelating agent selected from the group consisting of salts of methyl glycine diacetic acid (MGDA), salts of glutamatic acid diacetic acid (GLDA) and salts of citric acid.

6. The ADW composition according to claim 5, wherein
i) the at least one chelating agent is at least one compound selected from the group consisting of the tetra-sodium salt of GLDA, the trisodium salt of MGDA, of GLDA or of citric acid and the disodium salt of MGDA or of citric acid, and/or
ii) the salt of MGDA is provided as mixture of enantiomers, said mixture containing predominantly the respective L-enantiomer with an enantiomeric excess (ee) in the range of from 10 to 75%.

7. The ADW composition according to claim 1, further comprising a component (F)
(F) at least one bleaching agent.

8. The ADW composition according to claim 1 further comprising a component (G)
(G) at least one builder.

9. The ADW composition according to claim 1, wherein the ADW composition further comprises at least one component (H) to (L) selected from the group consisting of at least one enzyme (component (H)), at least one zinc salt (component (I)), at least one antifoam (component (J)), water or at least one solvent (component (K)) and further additives (component (L)).

10. The ADW composition according to claim 1, comprising
(A) at least one imidazole-based compound, selected from the group consisting of unsubstituted or at least monosubstituted imidazole and benzimidazole, and a salt of such imidazole-based compounds,
wherein the substituents are selected from the group consisting of C₁-C₃₀-alkyl, C₆-C₁₄-aryl, C₇-C₃₀-aralkyl, —NO₂, —NH₂, C₁-C₆-alkoxy, —COOH, halogen and —OH,
and the alkyl or aryl fragments of the substituents may in turn be at least monosubstituted by —COOH, —NH₂, C₁-C₆-alkyl, halogen, C₁-C₆-alkoxy, —NO₂ or —OH,
(B) at least one polyalkylene imine,
(C) at least one silicate,
(D) at least one chelating agent,
(E) at least one non-ionic surfactant according to general formula (I)
R¹—CH(OH)—CH₂—O-(AO)ₓ—R² (I)
wherein:
R¹ is selected from the group consisting of C₄-C₃₀-alkyl, straight-chain or branched, and C₄-C₃₀-alkylene, straight-chain or branched, with at least one C—C double bond,
R² is selected from the group consisting of C₁-C₃₀-alkyl, straight-chain or branched, and C₂-C₃₀-alkylene, straight-chain or branched, with at least one C—C double bond,
x is selected from the group consisting of one to 100, and
AO is identical or different alkylene oxides, selected from the group consisting of CH₂—CH₂—O, (CH₂)₃—O, (CH₂)₄—O, CH₂CH(CH₃)—O, CH(CH₃)—CH₂—O— and CH₂CH(n-C₃H₇)—O,
(F) at least one bleaching agent,
(G) at least one builder comprising sodium sulfate, sodium carbonate and/or at least one homopolymer of (meth)acrylic acid or a copolymer of acrylic acid with at least one comonomer selected from the group consisting of methacrylic acid, maleic acid, itaconic acid and AMPS,
and optionally comprising at least one further one further component (H) to (L) selected from the group consisting of at least one enzyme (component (H)), at least one zinc salt (component (I)), at least one antifoam (component (J)), water or at least one solvent (component (K)) and further additives (component (L)).

11. A process for cleaning dishware in an automatic dishwasher, said process comprising:
using at least one ADW composition according to claim 1 for cleaning the dishware in the automatic dishwasher.

12. A method of using at least one ADW composition according to claim 1, the method comprising: using the at least one ADW composition in automatic dishwashing and/or as corrosion inhibitor during automatic dishwashing processes.

13. The method according to claim 12, wherein the corrosion is silver and/or aluminium corrosion on items to be dishwashed (dishware), metal corrosion within the interior of the automatic dishwasher and/or glass corrosion on the items to be dishwashed.

14. A method of using a mixture of at least one imidazole-based compound (component (A)) according to claim 1 and a further component (B), at least one polyalkyleneimine, the method comprising: using the mixture of the component (A) and the further component (B) as corrosion inhibitor.

15. (canceled)

16. (canceled)

17. A method of using at least one ADW composition according to claim 1, the method comprising: using the at least one ADW composition in automatic dishwashing and/or as corrosion inhibitor, in order to reduce any corrosion at least partially, during automatic dishwashing processes.

18. The ADW composition according to claim 1, comprising
(A) at least one imidazole-based compound selected from the group consisting of imidazole, 2-ethyl-imidazole, 2-propyl-imidazole, 8-octyl-imidazole, 1-ethyl-4-methyl-imidazole, 2-ethyl-4-methyl-imidazole, 2-amino-3-(1H-imidazol-4-yl)propanoic acid (histidine), 4-methyl-1-p-tolylimidazole, 2-methyl-benzimidazole, benzimidazole and 5-nitro-benzimindazole,
(B) at least one polyalkylene imine,
(C) at least one silicate,
(D) at least one chelating agent,
(E) at least one non-ionic surfactant according to general formula (I)
R¹—CH(OH)—CH₂—O-(AO)ₓ—R² (I)
wherein:
R¹ is selected from the group consisting of C₄-C₃₀-alkyl, straight-chain or branched, and C₄-C₃₀-alkylene, straight-chain or branched, with at least one C—C double bond,
R² is selected from the group consisting of C₁-C₃₀-alkyl, straight-chain or branched, and C₂-C₃₀-alkylene, straight-chain or branched, with at least one C—C double bond,
x is selected from the group consisting of one to 100,
AO is identical or different alkylene oxides, selected from the group consisting of CH₂—CH₂—O, (CH₂)₃—O, (CH₂)₄—O, CH₂CH(CH₃)—O, CH(CH₃)—CH₂—O—and CH₂CH(n-C₃H₇)—O,
(F) at least one bleaching agent,
(G) at least one builder comprising sodium sulfate, sodium carbonate and/or at least one homopolymer of (meth)acrylic acid or a copolymer of acrylic acid with at least one comonomer selected from the group consisting of methacrylic acid, maleic acid, itaconic acid and AMPS,
and optionally comprising at least one further one further component (H) to (L) selected from the group consisting of at least one enzyme (component (H)), at least one zinc salt (component (I)), at least one antifoam (component (J)), water or at least one solvent (component (K)) and further additives (component (L)).

19. The ADW composition according to claim 1 further comprising a component (B)
(B) at least one polyethyleneimine or polypropyleneimine.

20. The ADW composition according to claim 1 further comprising a component (C)
(C) at least one sodium silicate, potassium silicate or alumino silicate.

21. The ADW composition according to claim 1, wherein the imidazole-based compound is selected from the group consisting of imidazole, 2-ethyl-imidazole, 2-propyl-imidazole, 8-octyl-imidazole, 1-ethyl-4-methyl-imidazole, 2-ethyl-4-methyl-imidazole, 2-amino-3-(1H-imidazol-4-yl)propanoic acid (histidine), 4-methyl-1-p-tolylimidazole, 2-methyl-benzimidazole, benzimidazole and 5-nitro-benzimindazole.

22. The ADW composition according to claim 1, further comprising a component (D)
(D) at least one chelating agent selected from the group consisting of an alkali metal salt and an ammonium salt.
